(19) United States
(12) Patent Application Publication
(10) Pub. No.: US 2009/0003156 A1
(43) Pub. Date: Jan. 1, 2009

(54) Information Recording Apparatus, Information Recording Control Method, and Information Recording Control Program

(75) Inventor: Takashi Nakamura, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/161,629

(22) PCT Filed: Jan. 18, 2007
(86) PCT No.: PCT/JP2007/050646

§ 371 Date: Jul. 21, 2008

(30) Foreign Application Priority Data
Jan. 24, 2006 (JP) 2006-015707

(51) Int. Cl. G11B 20/10

(52) U.S. Cl. 369/47.11; G9B/20.009

(57) ABSTRACT

The present invention provides an information recording apparatus, an information recording control method, and an information recording control program, which can secure the continuity of recording information on a disc-shaped recording medium by a simple method, without carrying out a process of synchronizing the timing of re-start of recording operation with the detection of recording stop position or the like.

A system control unit 113 monitors whether a data amount of image-forming data temporarily stored in a buffer memory 109 is lacking, and determines whether the recording of image on a label surface of the optical disc 10 should be temporarily stopped. In a case where it is determined that the recording of image should be temporarily stopped, while a reading process and a conversion process of an encoder 111, and an output process of a laser drive circuit 112 are continued, dummy data for stopping the forming of change portion of visible-light characteristic in an image-forming layer of the optical disc 10 for one turn is stored in the buffer memory 109. Thus, the dummy data is read by the encoder 111.

### TECHNICAL FIELD

The present invention relates to a technical field of an information recording apparatus, an information recording control method, and an information recording control program, which record information on a disc-shaped recording medium.

### BACKGROUND ART

In a field of optical disc such as CD (Compact Disc), and DVD (Digital Versatile Disc), recently, a technique in which a laser for recording information on an information-recording surface is used to form a visually recognizable image on a label surface opposite thereto has become to a practical use (for example, “Label Flash” (Trademark), “Light Scribe” (Trademark)).

As an example of optical disc based on such technique, an optical disc is taken, in which an image-forming layer which contains an organic dye film or the like whose visible-light characteristic changes with the emission of laser light with power equal to or more than a predetermined power is formed under a protective layer at a side of label surface.

As an example of method of forming an image on such optical disc, first, desired image data is divided into one turn of image-forming data for each predetermined radial interval of optical disc in a host computer, and the image-forming data is successively outputted to an optical disc recording apparatus. In an optical disc recording apparatus, an optical disc which has been placed on a turn-table in an upside-down manner as compared with usual information recording is rotated by a spindle motor. Image-forming data inputted from a host computer is temporarily stored in a buffer memory, and the stored image-forming data is read, and modulated by an encoder, and is then outputted to a laser drive circuit. The laser drive circuit drives a laser diode of optical pickup, so that a laser light is irradiated on an image-forming layer of rotating optical disc in a pattern corresponding to the image-forming data for one turn. Thus, visible-light characteristic of image-forming layer changes, so one turn of image is recorded on the optical disc at a radial position where the optical pickup has been positioned. After that, the optical pickup is radially moved by a predetermined interval, and a laser light corresponding to a further-inputted image-forming data is irradiated for one turn. As the irradiation of the laser light and the movement of the optical pickup are thus repeated, the image recording is completed for each interval, resulting in a desired image being formed on a label surface of optical disc.

During a period of time during which the above-mentioned optical disc recording apparatus forms an image, in a case where a input rate of image-forming data from a host computer does not catch up with a recording rate, and there becomes no image-forming data to be read from a buffer memory, the continuity of recording of image-forming data on an optical disc is obstructed, so that an image is not formed appropriately, resulting in a problem of occurrence of so-called under-run of buffer.

As measures to prevent such condition, for example, it is thought to apply a technique of coping with buffer under-run at the time of recording information on an information recording surface of optical disc by disc-at-once, track-at-once, or the like as disclosed in Patent Document 1. In this case, when it becomes to a condition in which buffer under-run occurs, a operation of recording on an optical disc is temporarily stopped by stopping a reading process of encoder or the like. When a sufficient image-forming data is stored in a buffer memory, a recording re-start position is brought into accord with a recording stop position on the optical disc to re-start a recording operation.

### Patent Document 1: Japanese Patent Laid-open No. 2000-149263

### DISCLOSURE OF THE INVENTION

### Problem to be solved by the Invention

However, in the above-mentioned measures, in order to bring a recording re-start position into accord with a recording stop position, a complicated process is necessary, such as a process of synchronizing the timing of re-start of recording operation with the detection of recording stop position.

The present invention has been accomplished in consideration of the above points, and it is an object of the invention to provide an information recording apparatus, an information recording control method, and an information recording control program, which can secure the continuity of recording information on a disc-shaped recording medium by a simple method without carrying out a process of synchronizing the timing of re-start of recording operation with the detection of recording stop position or the like.

### Means for Solving the Problem

In order to solve the above problem, one aspect of the invention relates to an information recording apparatus, comprising:

storing means for temporarily storing input information, recording means for forming a condition corresponding to the input information on a disc-shaped recording medium to carry out the recording of information on the disc-shaped recording medium, and

reading means for reading the input information stored in the storing means, and inputting it to the recording means,

wherein the information recording apparatus, comprises:

determining means for determining whether the recording of the input information on the disc-shaped recording medium is temporarily stopped, and

recording control means for, in a case where it is determined by the determining means that the recording on the disc-shaped recording medium is temporarily stopped, continuing a reading and input process by the reading means, and inputting dummy information to the reading means, the dummy information being for stopping the forming of changing portion of the condition on the disc-shaped recording medium for a predetermined number of turns.

Another aspect of the invention relates to an information recording control method in an information recording apparatus, comprising:

storing means for temporarily storing input information,

recording means for forming a condition corresponding to the input information on a disc-shaped recording medium to carry out the recording of information on the disc-shaped recording medium, and

reading means for reading the input information stored in the storing means, and inputting it to the recording means,

wherein the information recording control method, comprises:

a determining process of determining whether the recording of the input information on the disc-shaped recording medium is temporarily stopped, and

a recording control process of, in a case where it is determined by the determining process that the recording on the disc-shaped recording medium is temporarily stopped, continuing a reading and input process by the reading means, and inputting dummy information to the reading means, the dummy information being for stopping the forming of changing portion of the condition on the disc-shaped recording medium for a predetermined number of turns.

Still another aspect of the invention relates to an information recording control program, causing a computer included in an information recording apparatus, comprising:

storing means for temporarily storing input information,

recording means for forming a condition corresponding to the input information on a disc-shaped recording medium to carry out the recording of information on the disc-shaped recording medium, and

reading means for reading the input information stored in the storing means, and inputting it to the recording means,

to function as:

determining means for determining whether the recording of the input information on the disc-shaped recording medium is temporarily stopped, and

recording control means for, in a case where it is determined by the determining means that the recording on the disc-shaped recording medium is temporarily stopped, continuing a reading and input process by the reading means, and inputting dummy information to the reading means, the dummy information being for stopping the forming of changing portion of the condition on the disc-shaped recording medium for a predetermined number of turns.

### BRIEF DESCRIPTION OF THE DRAWINGS

FIG. 1 is a block diagram showing an example of schematic configuration of optical disc recording apparatus 1 according to the embodiment.

FIGS. 2A to 2E are views showing an example of a manner where data is stored in a buffer memory 109, and a manner where an image is recorded on an optical disc 10.

FIGS. 3A to 3D are views showing an example of a manner where data is stored in a buffer memory 109, and a manner where an image is recorded on an optical disc 10.

FIG. 4 is a flow chart showing an example of processing of system control unit 113 in an optical disc recording apparatus 1 according to the embodiment.

### EXPLANATION OF REFERENCE CHARACTERS

1: optical disc recording apparatus
2: host computer
10: optical disc
101: spindle motor
102: frequency generator
103: stepping motor
104: optical pick-up
105: RF amplifier
106: servo circuit
107: decoder
108: interface
109: buffer memory
110: PLL
111: encoder
112: laser drive circuit
113: system control unit

### BEST MODE FOR CARRYING OUT THE INVENTION

Referring now to the drawings, the best embodiment of the invention will be described in detail. The embodiment described below is an embodiment in which the invention has been applied to an optical disc recording apparatus which records information on an information recording surface of a recordable DVD such as DVD-R, DVD-RW, or the like (hereinafter, simply referred to as an optical disc), and forms a visibly-recognizable image on its label surface.

[1. Configuration, Function, and the like of Optical Disc Recording Apparatus]

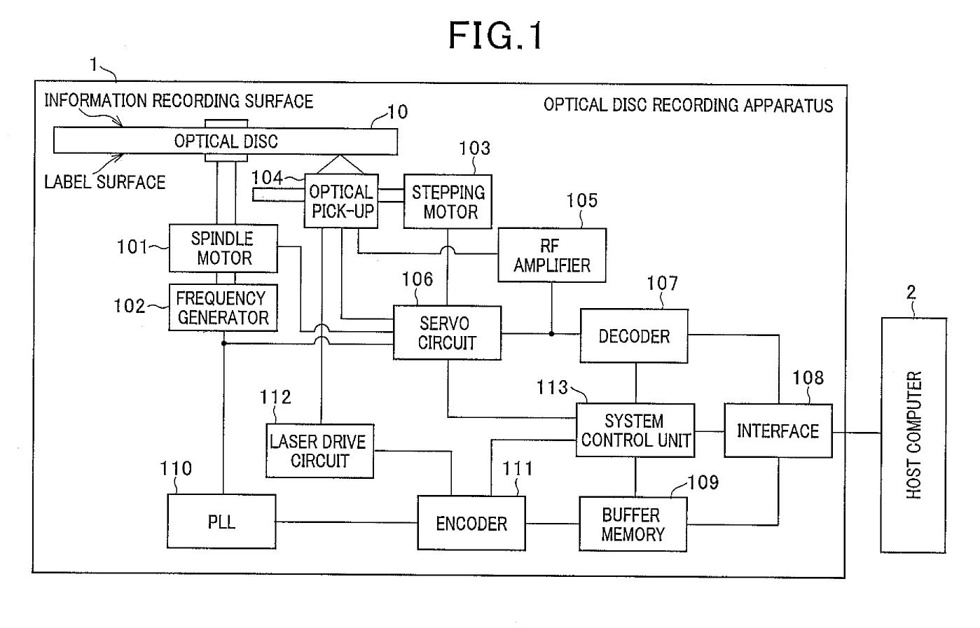

First, a configuration and a function of optical disc recording apparatus according to the embodiment will be described with reference to FIG. 1.

FIG. 1 is a block diagram showing an example of schematic configuration of optical disc recording apparatus 1 according to the embodiment.

As shown in FIG. 1, an optical disc recording apparatus 1 is arranged to include a spindle motor 101, a frequency generator 102, a stepping motor 103, an optical pick-up 104 as recording means, an RF (Radio Frequency) amplifier 105, a servo circuit 106, a decoder 107, an interface 108, a buffer memory 109 as storage means, a PLL (Phase Locked Loop) 110, an encoder 111, a laser drive circuit 112, and a system control unit 113 as an example of determining means, recording control means, and movement control means. The encoder 111 and the laser drive circuit 112 constitute an example of reading means.

The optical disc recording apparatus 1 is arranged to be connected to a host computer 2 through the interface 108. The optical disc recording apparatus 1 is arranged to input content data (for example, audio data, image data, another data, program, or the like) outputted from the host computer 2, record the content data on an information recording surface of optical disc 10, and input image-forming data (an example of input information) outputted from the host computer 2, and form an image on a label surface of the optical disc 10 based on the image-forming data.

The host computer 2 is composed of, for example, a CPU (Central Processing Unit), a RAM (Random Access Memory), a ROM (Read Only Memory), a storage unit (for example, a hard disc drive, or the like), a display unit (for example, a liquid crystal display, or the like), an operation unit (for example, a key board, a mouse, or the like), and the like. Image data, an image-forming application program, and the like are stored in the storage unit. In the host computer 2, when the CPU reads and executes an image-forming application program stored in the storage unit, an image-forming data is produced based on an image data stored in the storage unit, and the image-forming data is outputted to the optical disc recording apparatus 1, and the host computer 2 controls the optical disc recording apparatus 1 to form an image on a label surface of the optical disc 10.

Concretely, the production of image-forming data is carried out as follows: for example, when a certain position is designated by a user or the like on an image displayed by a display unit based on an image data, on a circumference for each radially predetermined interval with the designated position set to a center of circle, color or the like of pixels positioned for each predetermined angle of the circumferential direction is converted to data which is defined in black and white, gray scale, or the like.

The optical disc 10 as an example of disc-shaped recording medium is loaded, for example, to a tray of loading mechanism not shown which is provided in the optical disc recording apparatus 1, so as to be inserted to the optical disc recording apparatus 1, and supported by a turn-table not shown. The optical disc 10 is formed of, for example, a transparent substrate of polycarbonate or the like, a recording layer of organic dye film, phase change film, or the like, a reflective layer, an image-forming layer of organic dye film or the like, and a protective layer of polycarbonate or the like in this order from an information recording surface to a label surface (each not shown).

When laser light with power corresponding to content data is irradiated to an image-forming layer from a side of information recording surface of the optical disc 10, color-change of dye, change of phase, or the like is made in the irradiated portion in a case where the power of the irradiated laser light is equal to or more than a predetermined power, while color-change of dye, change of phase, or the like is not made in the irradiated portion in a case where the power of the irradiated laser light is less than a predetermined power. Thus, a condition corresponding to the content data is formed, so that information is recorded.

On the other hand, when laser light with power corresponding to image-forming data is irradiated to an image-forming layer from a side of label surface of the optical disc 10, change of visible-light characteristic (an example of change of condition) is made in the irradiated portion in a case where the power of the irradiated laser light is equal to or more than a predetermined power (hereinafter, referred to as writing power), while change of visible-light characteristic is not made in the irradiated portion in a case where the power of the irradiated laser light does not reach the writing power. Thus, a condition corresponding to the image-forming data is formed, so that an image (an example of information) is recorded.

The spindle motor 101 is arranged to rotate the turn-table to rotate the optical disc 10 supported by the turn-table, and the rotational speed is arranged to be controlled by the servo circuit 106. In the present embodiment, in order to record data and form an image in a manner of CAV (Constant Angular Velocity) the spindle motor 101 is rotated at a constant angular velocity.

The frequency generator 102 is arranged to generate an FG (Frequency Generator) signal for each rotational angle which is derived from a division of one revolution of the spindle motor by a predetermined number, and output the FG signal to the servo circuit 106 and the PLL 110.

The stepping motor 103 is arranged to be rotated based on a drive signal outputted from the servo circuit 106 to move the optical pickup 104 radially of the optical disc 10.

The optical pick-up 104 is arranged to include, for example, a laser diode, an objective lens, an actuator, an optical sensor, and the like, and laser light with power corresponding to a drive signal outputted from the laser drive circuit 112 is irradiated by the laser diode, so that the laser light is irradiated to the optical disc 10 by the objective lens. The optical pick-up 104 is arranged to detect reflective light from the optical disc 10 by a photo-sensor, and output the detection signal to the RF amplifier 105. Further, the optical pick-up 104 is arranged to move the objective lens radially and vertically of the optical disc 10 based on a correction signal outputted from the servo circuit. Thus, a tracking control and a focusing control are realized.

The RE amplifier 105 is arranged to amplify a detection signal outputted from the optical pick-up 104, and output it as an RF signal to the servo circuit 106 and the decoder 107.

The servo circuit 106 is arranged to carry out a rotational control of the spindle motor 101, a control of radial position of the optical pick-up 104, a tracking control and a focusing control of the optical pick-up 104, under control of the system control unit 113. Concretely, the servo circuit 106 is arranged to produce a drive signal based on an input interval of the FG signal outputted from the frequency generator 102, and output the drive signal to the spindle motor 101, so as to control a rotational velocity of the spindle motor 101. Further, the servo circuit 106 is arranged to control the rotation of the stepping motor based on an indication signal outputted from the system control unit 113, and move the optical pick-up 104 to a radial position (a track in a case where the recording is carried out for an information recording surface) indicated by the system control unit 113 in the optical disc 10. Further, the servo circuit 106 is arranged to produce a correction signal based on an RF signal outputted by the RF amplifier 105, and output the correction signal to the optical pick-up 104 so as to carry out a tracking control and a focusing control.

The decoder 107 is arranged to carry out demodulation, an error correction, or the like for RF signal outputted by the RF amplifier to produce reproduction data, and output the reproduction data to the interface 108 or the system control unit 113.

The interface 108 is arranged to carry out an interface process between the optical disc recording apparatus 1, and the host computer 2. Concretely, the interface 108 is arranged to store content data and image-forming data outputted from the host computer in the buffer memory 109, and output reproduction data outputted from the decoder 107 to the host computer 2. Further, when a control data for controlling an operation of the optical disc recording apparatus 1 is outputted from the host computer 2, the interface 108 is arranged to output the control data to the system control unit 113.

The buffer memory 109 is arranged to temporarily store content data and image-forming data outputted from the host computer 2. Data stored in the buffer memory 109 is arranged to be read by the encoder 111 prior to later-stored data (namely, storing and reading according to a manner of FIFO (First-In First-Out) is carried out).

The PLL 110 is arranged to multiply an FG signal outputted from the frequency generator 102 to produce a PLL signal with the frequency obtained by multiplying the frequency of the FS signal with a predetermined multiple, and output the PLL signal to the encoder 111.

The encoder 111 is arranged to, under control of the system control unit 113, read data stored in the buffer memory 119 in synchronization with a PLL signal outputted from the PLL 110, convert it to a recording data, and output the recording data to the laser drive circuit 112. Concretely, the encoder 111 is arranged to, at the time of recording on an information recording surface, add an error correction code to the read content data, and modulate it to produce recording data, and is arranged to, at the time of recording on a label surface, convert a format of the read image-forming data to a format suitable to image-forming to produce recording data.

The laser drive circuit 112 is arranged to drive a laser diode of the optical pick-up 104 in correspondence with the recording data outputted from the encoder 111 to produce a drive signal (an example of input information) for emitting laser light, and output the drive signal to the optical pick-up 104.

The system control unit 113 is composed of, for example, a CPU, a RAM, a ROM, an I/O port, and the like. The system control unit 113 is arranged such that the CPU reads and executes a variety of control programs (also including an information recording control program) stored in the ROM to control each unit of the optical disc recording apparatus 1, and function as determining means, recording control means, and movement control means.

Concretely, the system control unit 113 as determining means, when the recording of image based on image-forming data is carried out on a label surface of the optical disc 10, monitors a data amount of image-forming data temporarily stored in the buffer memory. The system control unit 113 is arranged to determine whether an amount of stored data is decreased to a degree in which there is the possibility that there occurs a buffer under-run (or whether image forming data is lacking in a case where it has become to a condition where a buffer under-run actually occurs), and function as recording control means to control to temporarily stop the recording of image, in a case where it is determined that there is the possibility that there occurs a buffer under-run, as mentioned below.

As a threshold of data amount on which it is determined whether there is the possibility that there occurs a buffer under-run (whether image forming data is lacking), for example, an amount of recording data of one turn or a plurality of turns corresponding to the radial position at which the next recording is to be carried out in the optical disc 10 may be available, or a threshold may be pre-set to a fixed one, or a threshold may be 0 (i.e., a case where image-forming data temporarily stored in a buffer memory has completely become null). An amount of recording data corresponding to one turn of optical disc is, for example, determined by a setting value pre-stored in a ROM of the system control unit 113, an image resolution designated by the host computer 2, or the like. Further, since the encoder 111 carries out a reading process in synchronization with a PLL signal outputted by the PLL 110 based on an FS signal outputted by the frequency generator 102 so that the recording operation is carried out at the timing corresponding to a rotational velocity of the optical disc 10, an amount of recording data for one turn of the optical disc becomes constant irrespective of the radial recording position.

When it is determined that there is the possibility that there occurs a buffer under-run, the system control unit 113 as recording control means controls to cause each unit to continue the recording operation for image-forming, including a reading process of the encoder 111, a conversion process, and an output process of drive signal of the laser drive circuit 112 (an input process of drive signal to the optical pick-up 104), while the system control unit 113 controls to cause dummy data (an example of dummy information) for stopping the forming of change portion of visible-light characteristic in an image-forming layer of the optical disc 10 to be inputted to the encoder 111.

Concretely, the system control unit 113 is arranged to produce dummy data which contains data indicative of color, tone, or the like by which a change of visible-light characteristic in an image-forming layer of the optical disc 10 is not formed, and store the dummy data in the buffer memory 109, so that the dummy data is read by the encoder 111 before image-forming data. Thus, the dummy data is read by the encoder 111, and converted to recording data, and a drive signal is outputted in correspondence with the recording data by the laser drive circuit 112 so that a laser diode of he optical pick-up 104 is driven. As a result, laser light which does not reach the recording power is irradiated (or the irradiation of laser light is stopped), and visible-light characteristic does not change in an image-forming layer. That is, it becomes to a condition where the recording of image is stopped.

For example, in a case where an image-forming layer of the optical disc 10 has such a property that the visible-light reflectivity rises (i.e., it is visually recognized as bright color, as compared with a condition before the visible-light characteristic changes) as the visible-light property changes, when image-forming data presents color with high brightness, an irradiation power of laser diode is drive-controlled by the laser drive circuit 112 to reach the a writing power. When image-forming data presents color with minimum brightness, an irradiation power of laser diode is drive-controlled not to reach the a writing power. In such case, therefore, if data indicative of black color or a minimum tone of brightness is set to dummy data, a visible-light property of image-forming layer does not change. To the contrary, in a case where the visible-light reflectivity decreases as the visible-light property of image-forming layer changes, it is sufficient that data of white color or data whose brightness presents the maximum tone is set to dummy data.

A data amount of dummy data stored in the buffer memory 109 is brought into consistence with an amount of recording data of one turn (or, a predetermined number of turns) at the radial position at which the optical pick-up 104 carries out the recording operation in correspondence to dummy data. Thus, from the position (the circumferential position of the optical disc 10) at which the recording of image has been stopped temporarily, a recording operation of dummy data is started (an image is not formed actually), and a recording operation of dummy data is carried out for one turn. As a result, the recording position of the optical pick-up 104 returns just to the position where the recording of image has been stopped temporarily. During a period of time, if an image-forming data sufficient for F re-starting the recording of image has been stored in the buffer memory 109, the image-forming data is read by the encoder 111 subsequently to dummy data, so that the recording is necessarily re-started from the position at which the recording of image has been stopped temporarily. On the other hand, during a period of time while sufficient image-forming data is not stored, dummy data is further stored, so the recording operation of dummy data continues. After that, when sufficient image-forming data is stored, and the recording of image is re-started, its position becomes finally to the position at which the recording has been stopped temporarily.

Thus, by a simple process of storing dummy data in the buffer memory 109, it is possible to secure the continuity of image recorded in a image-forming layer of the optical disc 10, without carrying out a complex synchronization operation of bringing the recording re-start position in accord with the recording stop position or the like.

The system control unit 113 as movement control means controls the servo circuit 106 to stop the radial movement of the optical pick-up 104 by the stepping motor 103, while the recording operation of dummy data is being carried out. Thus, the recording of image is re-started smoothly.

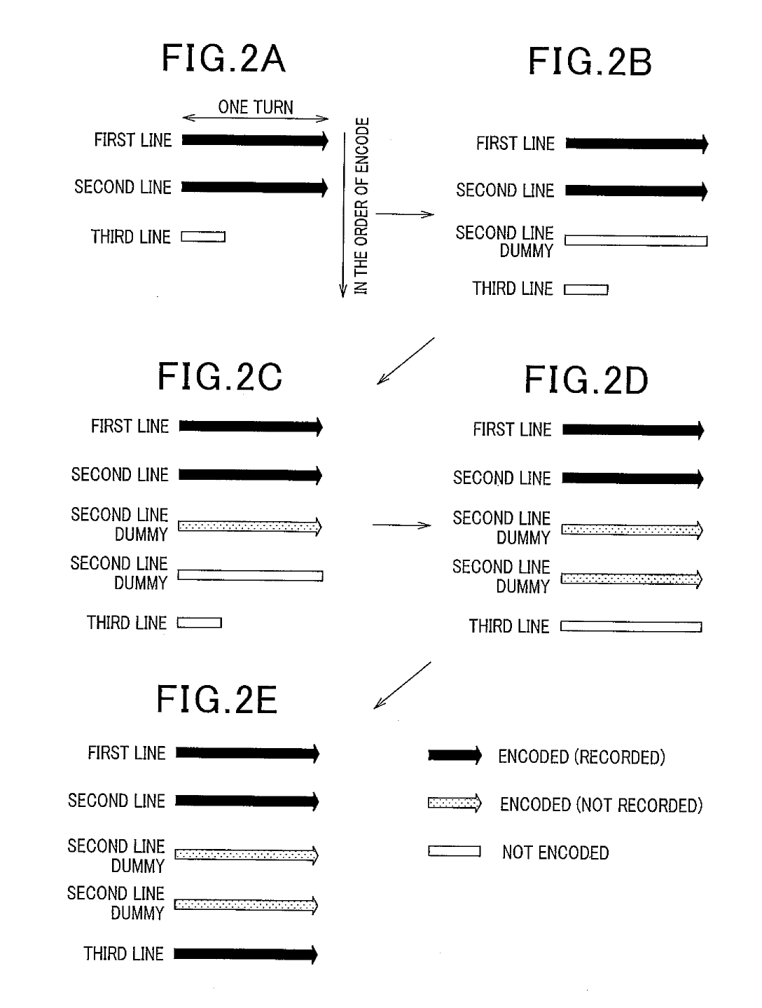

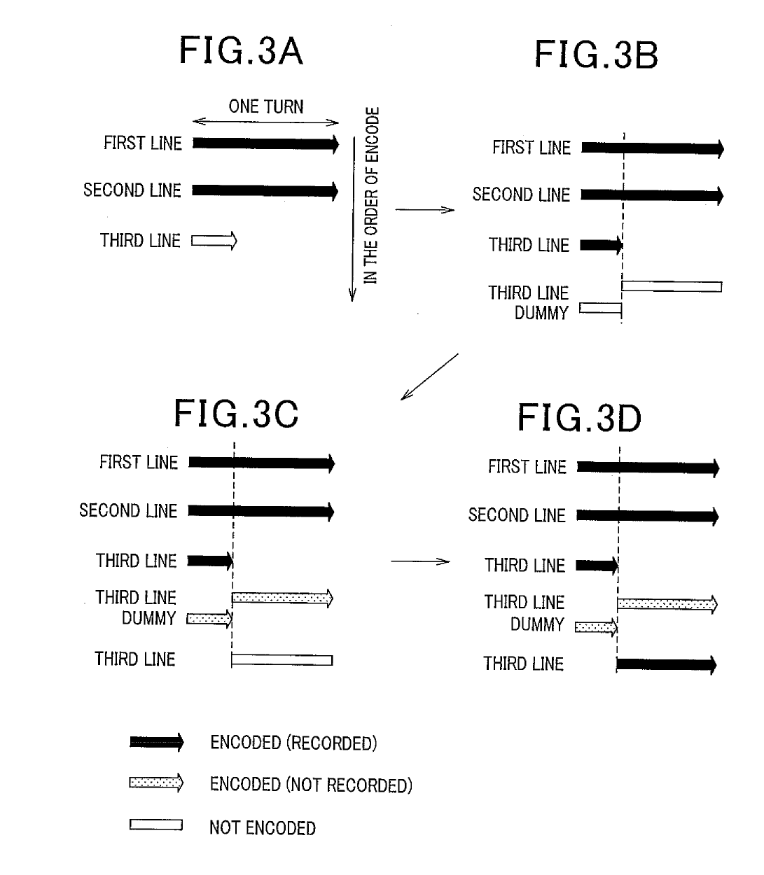

A concrete example of manner where an image is recorded under control of the system control unit 113 mentioned above will be explained with reference to FIGS. 2A to 2E and FIGS. 3A to 3D.

FIGS. 2A to 2E, and FIGS. 3A to 3D are views showing an example of a manner where data is stored in the buffer memory 109, and a manner where an image is recorded on the optical disc 10.

Here, the recording positions, spaced at a predetermined interval, of the optical disc 10 are referred to as first line, second line, third line, and the like from the radial position of start of the recording toward the outer circumference.

First, the first example is an example of case where a threshold value of data amount on which it is determined that there is the possibility that there occurs a buffer under-run is set to an amount of recording data corresponding to one turn of the optical disc 10.

As shown in FIG. 2A, image-forming data corresponding to one turn of first line and one turn of second line of the circumferences of the optical disc 10 is stored in the buffer memory 109. In this case, first, when image-forming data of first line is read by the encoder 111, and an image is recorded at the first line of the optical disc 10, the optical pick-up 104 is radially moved for a predetermined interval, and image-forming data of second line is read by the encoder 111, so an image is recorded at the radial position of the second line. Here, since a stored amount of image-forming data of third line does not reach an amount of one turn, dummy data of one turn is stored before image-forming data of third line, as shown in FIG. 2B. Thus, as shown in FIG. 2C, the radial movement of the optical pick-up 104 is stopped, and the dummy data is read by the encoder 111. At this time, although the recording operation continues, the image recording does not occur actually. At this time, since a stored amount of image-forming data of third line does not reach an amount of one turn, dummy data of one turn is further stored, and as shown in FIG. 2D, the dummy data is read by the encoder 111, and the recording operation continues. During this period of time, since one turn of image-forming data of third line has been stored, as shown in FIG. 2E, the radial movement of the optical pick-up 104 is re-started, and image-forming data of third line is read by the encoder 111, so an image is recorded at the radial position of third line. The recording re-start position of this time is a position where the recording is started at the radial position of third line, i.e., a position where the recording has been stopped temporarily.

Now, the second example is an example where a threshold value is set to 0.

First, as shown in FIG. 3A, in the same manner as in FIG. 2A, image-forming data is read by the encoder 111 in the order of first line and second line, so that an image is recorded, and as shown in FIG. 3B, a stored amount of image-forming data corresponding to a third line is read by the encoder, so that an image is recorded on the optical disc 10. When an amount of image-forming data has completely become null, and dummy data of one turn is stored, as shown in FIG. 3C, the dummy data is read by the encoder 111, and the recording operation continues in a condition where the radial movement of the optical pick-up 104 is stopped. During the period of time, when the remaining image-forming data of third line is stored, as shown in FIG. 3D, the remaining image-forming data is real by the encoder 111, and the recording of image is re-started from the position where the recording of image has been stopped temporarily.

### [2. Operation of Optical Disc Recording Apparatus]

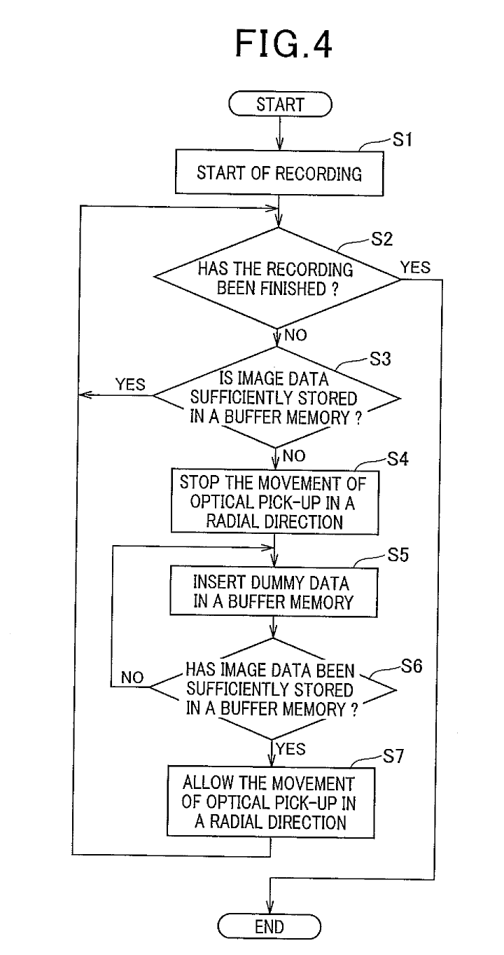

Now, an operation of the optical disc recording apparatus 1 in a case where an image is formed on a label surface of the optical disc 10 will be described with reference to FIG. 4. A method of recording content data on an information recording surface is known, so a detailed explanation thereof is omitted.

FIG. 4 is a flow chart showing an example of processing of system control unit 113 in an optical disc recording apparatus 1 according to the embodiment.

First, by a user, the optical disc 10 on which an image is to be formed is loaded in a tray with its label surface set downwardly (in the direction of irradiation of laser light), and is inserted into the optical disc recording apparatus 1, and is supported on a turn-table. The user operates the host computer 2, starts an application program for image-forming, selects desired image data, and instructs to form an image on a label surface. Thus, The host computer 2 produces image-forming data based on image data, outputs control data for instructing the optical disc recording apparatus 1 to form an image on a label surface, and outputs image-forming data successively from data of inner circumference.

The control data outputted from the host computer 2 is inputted to the system control unit 113 through the interface 108 in the optical disc recording apparatus 1. Thus, when the system control unit 113 outputs the servo circuit 106 a signal for instructing a rotation of the spindle motor 101 and the movement of the optical pick-up 104, the servo circuit 106 starts the rotational control of the spindle motor 101 and the rotational control of the stepping motor 103. When the rotation of the optical disc 10 stabilizes at a predetermined number of rotation in the spindle motor 101, and the optical pick-up 104 is moved by the stepping motor to a radial position at which the recording of image is started on the optical disc 10 (for example, a radial position designated by control data from the host computer 2, or the like), the system control unit 113 outputs the encoder 111 a control signal for instructing the start of conversion process.

On the other hand, image-forming data outputted from the host computer 2 is successively stored in the buffer memory 109 through the interface 108. As the encoder 111 starts the reading and conversion process of image-forming data from the buffer memory 109, a laser diode in the optical pick-up 104 is driven by a drive signal outputted from the laser drive circuit 112, so that the recording of image on a label surface of the optical disc 10 is started (FIG. 4, step S1).

After that, by the recording operation of each unit in the optical disc recording apparatus 1, an image is recorded from the inner circumference of the optical disc 10 by one line. In parallel with this operation, the system control unit 113 determines whether the recording of image has been completely finished (step S2). In a case where the recording has not been finished (step S2, NO), at a predetermined timing (for example, at the time when the recording of image for one turn has been finished, or the like), it is determined whether sufficient image-forming data is stored in the buffer memory 109 (for example, whether image-forming data for one turn is stored) (step S3). In a case where image-forming data is sufficiently stored (step S3, YES), a determining process continues (steps S2 to S3).

On the other hand, in a case where image-forming data is not stored sufficiently (step S3, NO), since there is the possibility of buffer under-run, the system control unit 113 controls the servo circuit 106 to stop the movement of the optical pick-up 104 in the radial direction of the optical disc 10 (step S4), and stores dummy data for one turn in the buffer memory 109 (step S5). Thus, dummy data is read by the encoder 111, and while the movement of the optical pick-up 104 in the radial direction is stopped, the recording operation of dummy data for one turn is continued. During this period of time, in a condition where the recording of image on the optical disc 10 does not occur actually, the optical disc 10 makes just one revolution.

Now, the system control unit 113 determines whether sufficient image-forming data has been stored in the buffer memory 109 (step S6). In a case where sufficient image-forming data has not yet been stored (step S6, NO), further dummy data for one turn is stored in the buffer memory 109 (step S5).

Thus, when sufficient image-forming data is stored in the buffer memory 109 while the recording operation of dummy data is continued (step S6, YES), the system control unit 113 terminates the storing of dummy data, and controls the servo circuit 106 to allow the movement of the optical pick-up 104 in the radial direction of the optical disc 10 (step S7). Then, image-forming data subsequent to the dummy data is read by the encoder 111, so that the recording of image is re-started from the position where the recording has been stopped temporarily.

Thus, an image is recorded on a label surface of the optical disc 10, and when all of the recording has been finished (step S2, YES), the system control unit 113 finishes the process.

As explained above, according to the embodiment, the system control unit 113 monitors whether a data amount of image-forming data temporarily stored in the buffer memory 109 is lacking, and determines whether the recording of image on a label surface of the optical disc 10 should be stopped temporarily. In a case where it is determined that the recording of image should be stopped temporarily, while the reading process and the conversion process of the encoder 111, and the output process of the laser drive circuit 112 (the input process of drive signal to the optical pick-up 104) are continued, dummy data for stopping the forming of change portion of visible-light characteristic in an image-forming layer of the optical disc 10 for one turn (or, a predetermined number of turns) is stored in the buffer memory 109, so the dummy data is read by the encoder 111.

Therefore, the recording operation of dummy data is continued for one turn from a position in the radical direction of the optical disc 10 where the recording of image is temporarily stopped. During the period of time, when sufficient image-forming data is stored in the buffer memory 109, the image-forming data is read by the encoder 111 subsequently to the dummy data. As a drive signal corresponding to the image-forming data is inputted to the optical pick-up 104, the recording of image is re-started from just a position where the recording has been temporarily stopped. Under the circumstances where a buffer under-run occurs, without a process of synchronizing there-start timing of the recording operation with the detection of recording stop position or the like, it is possible to secure the continuity of image formed on an image-forming layer of the optical disc 10.

Further, the dummy data is data which does not form a change portion of visible-light characteristic in an image-forming layer of the optical disc 10 by the recording operation of the optical pick-up 104. Therefore, while the operation of recording itself is continued, it is possible to temporarily stop the recording of image simply.

Further, since a data amount of dummy data is a data amount corresponding to an amount of recording data for one turn at F the recording position of the optical pick-up 104 in the radial direction of the optical disc 10, it is possible to securely re-start the recording from the position where the recording has been temporarily stopped.

Further, since the system control unit 113 controls to stop the recording position of the optical pick-up 104 in the radial direction of the optical disc 10 while the recording of image is temporarily stopped, it is possible to re-start the recording of image smoothly.

In the embodiment explained above, the dummy data is data for not forming a change portion of visible-light characteristic in an image-forming layer of the optical disc 10. However, for example, it is possible that control data for controlling the power of laser light by a laser diode of the optical pick-up 104 is included in dummy data. Concretely, for example, specific data which is not used for the recording of content data and the recording of image is regarded as recording stop control data and recording start control data, and the laser drive circuit 112 is arranged to recognize such control data. In the system control unit 113, the recording stop control data is set at the heading of dummy data, and the recording start control data is set at the last of dummy data. At this time, the content of data set between the heading and the last is arbitrary. As the dummy data is stored in the buffer memory 109 by the system control unit 113, the dummy data is read by the encoder 111, and is converted, and is inputted to the laser drive unit 112. At this time, in the laser drive circuit 112, as the recording stop control data positioned at the heading of the dummy data (which has been converted into recording data) is recognized, the power of laser light is controlled to be lower than a writing power, and as the recording start control data positioned at the last of the dummy data is recognized, the power of laser light is controlled to reach a writing power. Therefore, while the recording operation itself continues, it is possible to temporarily stop the recording of image securely. Further, for example, it is possible that recording stop control data is set for all from the heading to the last of dummy data, and while the recording stop control data is inputted to the laser drive circuit 112, the power of laser light is controlled to be lower than a writing power, and when data other than recording stop control data is inputted, the power of laser light is controlled to reach a writing power.

Further, in an arrangement of the embodiment, the buffer memory 109 stores image-forming data and dummy data, and the encoder 111 reads these data to produce recording data, and output it to the laser drive circuit 112. However, for example, it is possible that image-forming data and dummy data are directly inputted to the encoder 111, recording data produced by the encoder 111 is temporarily stored in the buffer memory 109, and the recording data is read by the laser drive circuit 112. In this case, the laser drive circuit 112 reads the recording data in synchronization with a PLL signal outputted from the PLL 110, and the system control unit 113 monitors a data amount of recording data stored in the buffer memory.

Further, in the embodiment, an image is recorded according to a CAV manner. However, for example, it is possible that an image is recorded according to a CLV (Constant Linear Velocity) manner.

Further, in the embodiment, the encoder 111 is arranged to carry out a reading process in synchronization with a PLL signal outputted by the PLL 110 based on an FG signal outputted by the frequency generator 102. However, for example, it is possible that a reading process is carried out in synchronization with a clock signal of fixed frequency or the like. In this case, since the timing of reading is fixed, in a case where a CAV manner is adopted, an amount of recording data for one turn of the optical disc is constant irrespective of the recording position in the radial direction. However, in a case where a CLV manner is adopted, the optical disc 10 is controlled to be rotated at a constant linear velocity, and as the recording position changes in the radial direction of the optical disc 10, an amount of recording data for one turn changes. Therefore, a data amount of dummy data for one turn to be stored in the buffer memory 109 or the like is, for example, calculated by the system control unit 113 based on the recording position of the radial direction.

Further, in the embodiment, the encoder 111 is arranged to convert a format of image-forming data to a format suitable for image-forming. However, for example, in a case where a format of image-forming data has already become to a format suitable for image-forming, the image-forming data itself as the recording data may be outputted to the laser drive circuit 112, without carrying out a conversion process. Or, it is possible that means other than the encoder 111 reads image-forming data, and outputs it as the recording data to the laser drive circuit 112.

Further, in the embodiment, in a case where image-forming data stored in the buffer memory 109 is lacking, and there is the possibility of buffer under-run, the recording of image is temporarily stopped. However, for example, it is possible that it is determined whether the recording of image is temporarily stopped based on another factor (for example, in a case where the recording of image is not carried out appropriately due to the disturbance of focusing control, or the like).

Further, in the embodiment, a case where an image is formed on a label surface of the optical disc 10 has been explained. However, for example, the present invention may be applied to a case where an image is formed on an information recording surface of the optical disc 10, or a case where usual content data is recorded on an information recording surface.

Further, in the embodiment, an information recording apparatus has been applied to an optical disc recording apparatus for recording content data or an image on a DVD. However, for example, it may be applied to an optical disc recording apparatus for recording on a CD, a Blue-ray disc, or the like, or may be applied to an information recording apparatus for recording on a disc-shaped recording medium.

The invention is not limited to the above embodiment. The above embodiment is an example. What has the substantially same configuration as technical idea included in the claims, and produces the substantially same operation and effect, is encompassed in a technical scope of the present invention, even if it takes any form.

All of disclosure of Japanese Patent Application No. 2006-15707 filed on Jan. 24, 2006, including the specification, the claims, the drawings, and the abstract, is incorporated by reference in its entirety.

1. An information recording apparatus, comprising:
a storing device which temporarily stores input information,
a recording device which forms a condition corresponding to the input information on a disc-shaped recording medium to carry out the recording of information on the disc-shaped recording medium, and
a reading device which reads the input information stored in the storing device, and inputs the input information stored in the storing means to the recording means device,
wherein the information recording apparatus, comprises:
a determining device which determines whether the recording of the input information on the disc-shaped recording medium is temporarily stopped, and
a recording control device which, in a case where it is determined by the determining device that the recording on the disc-shaped recording medium is temporarily stopped, continues a reading and input process by the reading device, and inputs dummy information to the reading device, the dummy information being for stopping the forming of changing portion of the condition on the disc-shaped recording medium for a predetermined number of turns.

2. An information recording apparatus according to claim 1,
wherein the dummy information is information on which a changing portion of the condition is not formed on the disc-shaped recording medium by a recording operation of the recording device.

3. An information recording apparatus according to claim 1,
wherein the dummy information includes control information for controlling the recording power of the recording device in such a way that a changing portion of the condition is not formed on the disc-shaped recording medium.

4. An information recording apparatus according to claim 1,
wherein an information amount of the dummy information is an amount of information corresponding to an amount of recording information for the predetermined number of turns at the recording position of the recording device in the radial direction of the disc-shaped recording medium.

5. An information recording apparatus according to claim 1,
wherein the information recording apparatus further comprises:
a movement control device which, in a case where it is determined by the determining device that the recording on the disc-shaped recording medium is temporarily stopped, stops the movement of the recording position of the recording device in the radial direction of the disc-shaped recording medium.

6. An information recording apparatus according to claim 1,
wherein the determining device, in a case where the input information stored in the storing device is lacking, determines that the recording of the input information on the disc-shaped recording medium is temporarily stopped.

7. An information recording apparatus according to claim 6,
wherein the determining device, in a case where an amount of the input information stored in the storing device is less than an amount of recording information for the predetermined number of turns at the recording position of the recording means in the radial direction of the disc-shaped recording medium, determines that the input information is lacking.

8. An information recording control method in an information recording apparatus, comprising:
a storing device which temporarily stores input information,
a recording device which forms a condition corresponding to the input information on a disc-shaped recording medium to carry out the recording of information on the disc-shaped recording medium, and
a reading device which reads the input information stored in the storing device, and inputs the input information stored in the storing means to the recording device,
wherein the information recording control method, comprises:
a determining process of determining whether the recording of the input information on the disc-shaped recording medium is temporarily stopped, and
a recording control process of, in a case where it is determined by the determining process that the recording on the disc-shaped recording medium is temporarily stopped, continuing a reading and input process by the reading device, and inputting dummy information to the reading device, the dummy information being for stopping the forming of changing portion of the condition on the disc-shaped recording medium for a predetermined number of turns.

9. A program recording medium where an information recording control program is computer-readably recorded,
the information recording control program causing a computer included in an information recording apparatus, comprising:
a storing device which temporarily stores input information,
a recording device which forms a condition corresponding to the input information on a disc-shaped recording medium to carry out the recording of information on the disc-shaped recording medium, and
a reading device which reads the input information stored in the storing device, and inputs the input information stored in the storing means to the recording device,
to function as:
a determining device which determines whether the recording of the input information on the disc-shaped recording medium is temporarily stopped, and
a recording control device which, in a case where it is determined by the determining device that the recording on the disc-shaped recording medium is temporarily stopped, continues a reading and input process by the reading device, and inputs dummy information to the reading device, the dummy information being for stopping the forming of changing portion of the condition on the disc-shaped recording medium for a predetermined number of turns.
